(19) United States
(12) Patent Application Publication
(10) Pub. No.: US 2022/0233931 A1
(43) Pub. Date: Jul. 28, 2022

(54) System and Method for Throwing a Ball and Retrieving the Ball from the Ground

(71) Applicant: Ao Jie Plastic Toys Factory Ltd., Kwun Tong (HK)

(72) Inventor: Wen Yu Hung, Kwun Tong (HK)

(73) Assignee: Ao Jie Plastic Toys Factory Ltd.

(21) Appl. No.: 17/157,981

(22) Filed: Jan. 25, 2021

(51) Int. Cl. A63B 65/12; A63B 47/02; A01K 15/02

(52) U.S. Cl. CPC A63B 65/122; A01K 15/025; A63B 47/02

(57) ABSTRACT

A throwing device for efficiently throwing a ball. The throwing device has a scoop. The scoop has a closed end, a first ball opening and a second ball opening. The first ball opening and the second ball opening intersect on the scoop. The first ball opening is at least as large as the ball. The second ball opening is normally smaller than the ball. The second ball opening expands when pressed against the ball. This enables the ball to pass into the scoop through the second ball opening. A shaft extends from the closed end of the scoop for manipulating the scoop and ball.

### BACKGROUND OF THE INVENTION

### 1. Field of the Invention

In general, the present invention relates to handheld devices that are used to throw a ball. More particularly, the present invention relates to handheld devices with scoops that can be used to both lift a ball off the ground and throw the ball at an increased velocity.

### 2. Prior Art Description

There are many devices that can be used to help a person throw a ball farther and faster. Many such devices have a scoop for holding a ball and a shaft for swinging the scoop. Many different forms of the scoop exist for throwing and catching a ball. For example, the sports of lacrosse and jai alai both have specialized scoops for throwing and catching balls.

Scoops are also commonly used to throw balls to dogs. This is because a scoop not only enables a person to throw the ball farther but it also enables a person to lift the ball without having to touch the ball with his/her hands. In this manner, the dog has to run farther to retrieve the ball and the person playing with the dog does not have to touch the dog's saliva present on the ball. Scoops specifically designed to throw balls to pets are exemplified by U.S. Pat. No. 5,290,039 to Cornelio and US Patent Application Publication No. 2017/0079243 to Ren.

Regardless of whether a scoop is used for a sport or if it is used for throwing a ball to a dog, there is a common problem shared by prior art throwing devices with scoops. In particular, it takes a good amount of skill to use the scoop to lift a stationary ball from the ground. In order to lift a ball from the ground, the scoop must be hooked under the ball without inadvertently moving the ball up and away from the scoop. This maneuver is difficult to master. As a result, many people inadvertently knock the ball away from the scoop as they attempt to capture the ball with the scoop.

In the prior art, the scoop on a typical throwing device has a single access point. As a result, a ball must enter and leave the scoop at the same general point. In order to throw a ball effectively, the opening of the scoop is generally perpendicular to the axis of the shaft. Although this orientation is good for throwing a ball, this orientation is very poor for retrieving a ball from the ground. If the shaft of the throwing device is straight and the scoop is perpendicular to the handle, the shaft must be positioned very close to the ground before the scoop is oriented in a manner that enables it to lift a ball. Such configurations are shown in U.S. Pat. No. 8,028,684 to Weissmann and U.S. Pat. No. 3,589,349 to Parker.

In order to make the lifting of a ball easier, a throwing device can use a curved shaft. Such configurations are shown in U.S. Pat. No. 7,686,001 to Fitt and U.S. Pat. No. 6,076,829 to Oblack. The curve of the shaft makes it easier to orient the scoop opening against a ball on the ground. However, the curve in the shaft detracts from the throwing capabilities of the device. As such, a compromise must be used where the throwing capability of the device is sacrificed in order to enhance the ease of ball retrieval.

A need therefore exists for an improved throwing device that can be easily used to retrieve a ball from the ground, without compromising the ability of the device to throw a ball. This need is met by the present invention as described and claimed below.

### SUMMARY OF THE INVENTION

The present invention is a throwing device for efficiently throwing a ball of a given ball diameter. The throwing device is specifically configured to work with any ball that has the same ball diameter. The throwing device has a scoop. The scoop has a closed end, a first ball opening and a second ball opening. The second ball opening is positioned opposite the closed end. The first ball opening is disposed between the closed end and the second ball opening. The first ball opening and the second ball opening intersect on the scoop at an intersect angle that is near perpendicular.

The first ball opening has a first diameter that is at least as large as the ball diameter. The second ball opening has a second diameter that is smaller than the ball diameter. The second ball opening expands to a size larger than the ball diameter when the ball is biased against the second ball opening with a sufficient force. This enables the ball to pass into the scoop through the second opening.

A shaft extends from the closed end of the scoop. The shaft terminates with a handle. The shaft is contoured to enable a standing person to position the second ball opening of the scoop against a ball on the ground. The contour of the shaft also enables a standing person to swing the scoop and cause the ball to exit the scoop through the first ball opening at the arc of the swing.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of a throwing device shown in conjunction with a ball during a ball throwing action;

FIG. 2 is a perspective view of an exemplary embodiment of a throwing device shown in conjunction with a ball during a ball loading action;

FIG. 3 is an enlarged front view of the scoop used in the exemplary throwing device;

FIG. 4 is a rear view of an exemplary embodiment of a throwing device;

FIG. 5 shows a person holding the exemplary embodiment of the throwing device;

FIG. 6 is an enlarged view showing the scoop of the throwing device initially engaging a ball; and

FIG. 7 is an enlarged view showing the scoop of the throwing device fully engaged with a ball.

### DETAILED DESCRIPTION OF THE DRAWINGS

Although the present invention throwing system can be embodied in many ways, only one exemplary embodiment is illustrated. The exemplary embodiment is being shown for the purposes of explanation and description. The exemplary embodiment is selected in order to set forth one of the best modes contemplated for the invention. The illustrated embodiment, however, is merely exemplary and should not be considered a limitation when interpreting the scope of the appended claims.

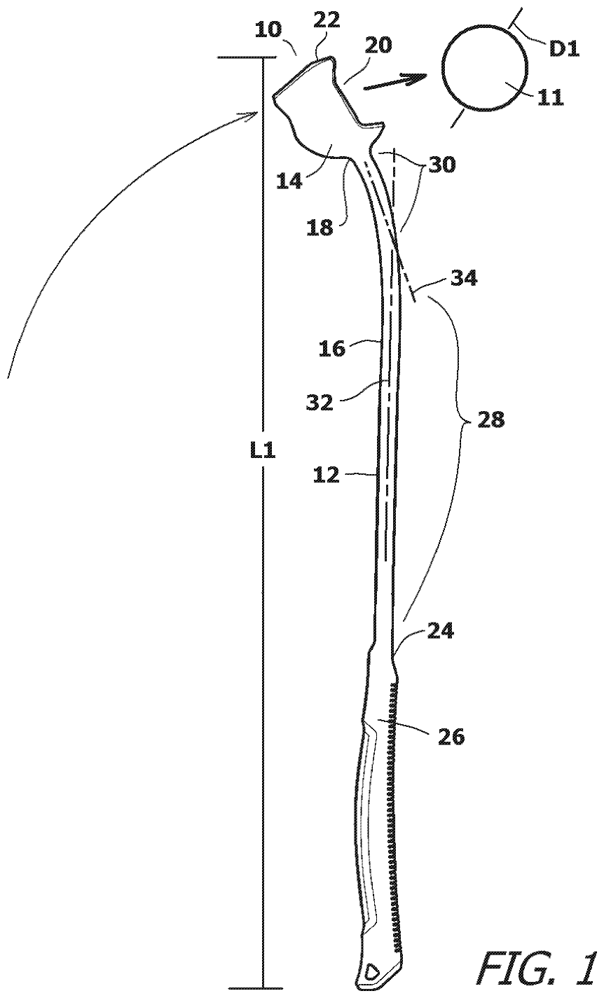

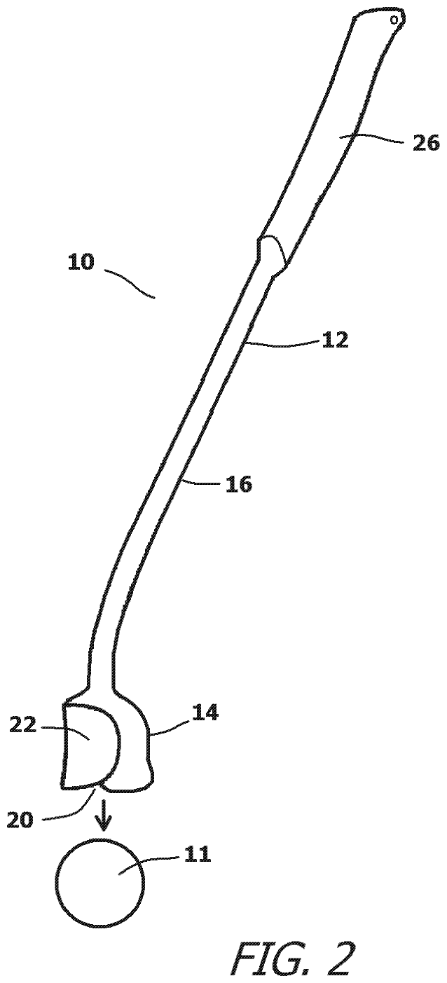

Referring to FIG. 1 and FIG. 2, a system 10 is shown. The system 10 includes a ball 11 and a throwing device 12 for throwing the ball 11. The ball 11 has a diameter D1. The throwing device 12 has a scoop 14 that is disposed at a first end 18 of a shaft 16. As will be explained in greater detail, the scoop 14 has two ball openings 20, 22. A first ball opening 20 is used to expel the ball from the scoop 14. The first ball opening 20 provides a release angle that is optimized to effectively throw the ball 11 a long distance at an optimized velocity. The second ball opening 22 is used to retrieve the ball 11 from the ground. The second ball opening 22 is oriented so that the ball 11 can be retrieved without causing a user to bend significantly.

The scoop 14 is positioned at the first end 18 of the shaft 16. The opposite second end 24 of the shaft terminates with a handle 26 for grip comfort. The shaft 16 and handle 26 have a combined length L1. The length L1 may vary depending upon the stature of the intended user. The preferred length L1 is between 50 cm and 70 cm.

The shaft 16 has a straight section 28 and an inclined section 30. The straight section 28 progresses along a first axis 32 for a distance between 70 percent and 90 percent of the overall length L1. The inclined section 30 is the shorter section and progresses along a second axis 34. The second axis 34 is co-planar with the first axis 32 but is inclined relative to the first axis 32 by a preferred offset angle of between 30 degrees and 45 degrees.

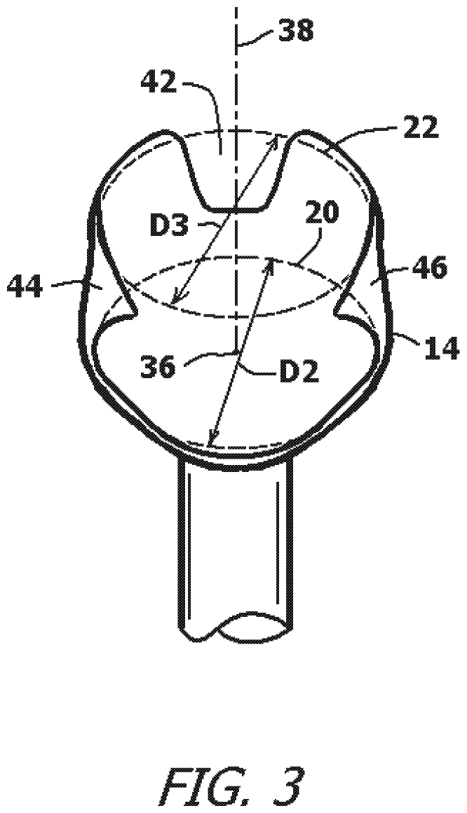

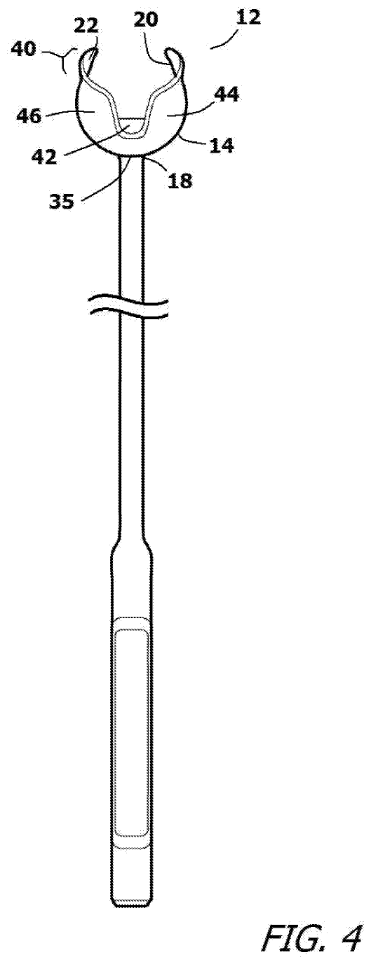

Referring to FIG. 3 and FIG. 4 in conjunction with FIG. 1 and FIG. 2, it can be seen that the scoop 14 has a complex shape. The scoop 14 is a generally bell-shaped structure, wherein the closed end 35 of the bell-shaped scoop 14 is attached to the first end 18 of the shaft 16. The scoop 14 defines an interior 36 that is large enough to accommodate the ball 11. The interior 36 of the scoop 14 can be accessed by the ball 11 through both the first ball opening 20 and the second ball opening 22. The second ball opening 22 is positioned opposite the closed end 35. The first ball opening 20 is disposed between the closed end 35 of the scoop 14 and the second ball opening 22. The interior 36 of the scoop 14 has a mid-axis 38 that is concentric with the second axis 34 of the inclined section 30 of the shaft 16. The first ball opening 20 is oriented generally parallel to the mid-axis 38 plus/minus ten degrees. Conversely, the second ball opening 22 is oriented generally perpendicular to the mid-axis 38 plus/minus ten degrees. As a result, the first ball opening 20 and the second ball opening 22 intersect generally at a perpendicular, plus/minus twenty degrees. That is, the intersection angle between the first ball opening 20 and the second ball opening 22 is preferably between 70 degrees and 110 degrees.

The first ball opening 20 has a maximum diameter D2, which is equal to, or slightly larger than, the diameter D1 of the ball 11. Consequently, the ball 11 can pass through the first ball opening 20 with little or no resistance. Conversely, the second ball opening 22 has a minimum diameter D3 that is slightly smaller than the diameter D1 of the ball 11. The second ball opening 22 is defined within a beveled section 40. Within the beveled section 40, the second ball opening 22 flares from its minimum diameter D3, that is smaller than the diameter D1 of the ball 11, to a larger rim diameter that is larger than the diameter D1 of the ball 11.

A slotted opening 42 is formed into the structure of the scoop 14 opposite the first ball opening 20. Both the slotted opening 42 and the first ball opening 20 intersect the second ball opening 22. Since the slotted opening 42 and the first ball opening 20 are on opposite sides of the scoop 14 and both openings are joined by the second ball opening 22, the scoop 14 is divided into two opposing segments 44, 46. The first segment 44 extends from the first ball opening 20 to the slotted opening 42 in a first direction. The second segment 46 is the mirror image and extends from the first ball opening 20 to the slotted opening 42 in the opposite direction. The division of the scoop 14 into a first segment 44 and a second segment 46, enables the first segment 44 and the second segment 46 to independently flex in opposite directions. The minimum diameter D3 of the second ball opening 22 is interposed between the first segment 44 and the second segment 46. Since the first segment 44 and the second segment 46 can flex, the minimum diameter D3 of the second ball opening 22 can change.

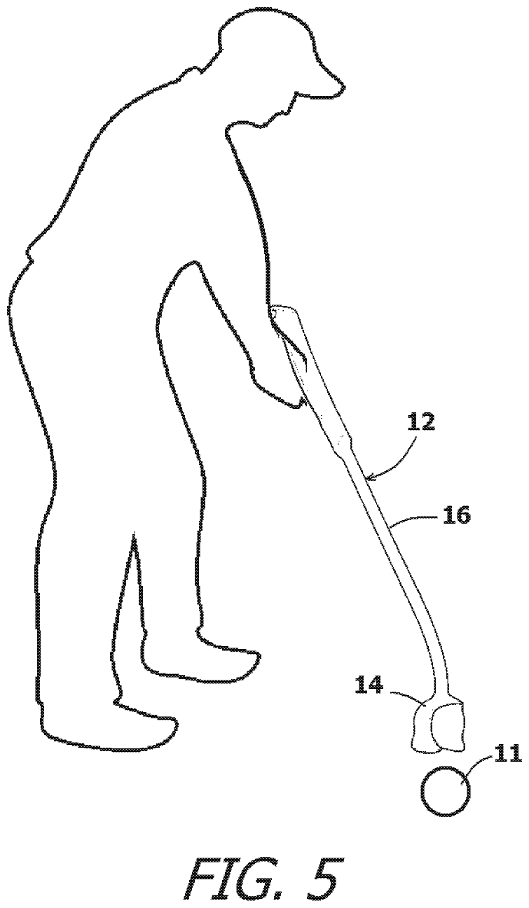

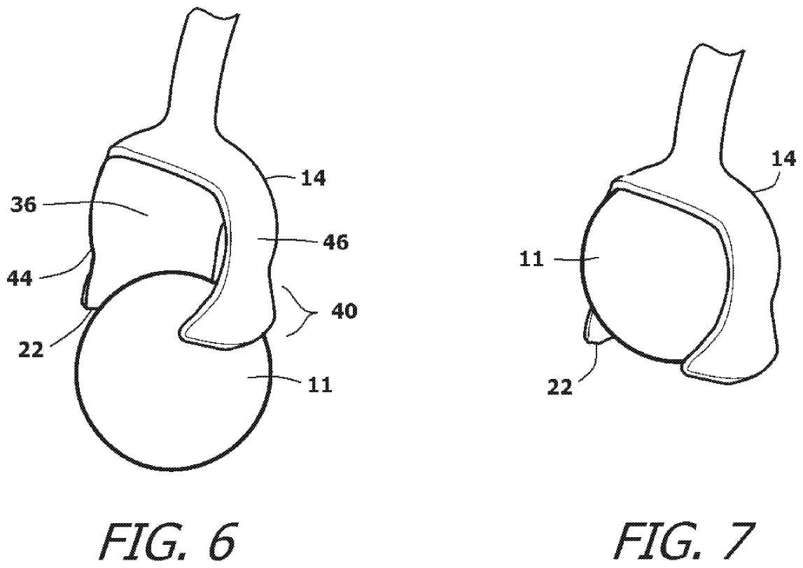

Referring to FIG. 5, FIG. 6 and FIG. 7, it can be seen that the shaft 16 of the throwing device 12 is long enough and is shaped to enable the scoop 14 to contact a ball 11 on the ground while the user is standing. In this position, the second ball opening 22 on the scoop 14 can be aligned above the ball 11. Once aligned, the user biases the scoop 14 against the ball 11 with a slight downward force. The ball 11 enters the wide end of the beveled section 40. Upon application of the downward force, the ball 11 contacts the first segment 44 and the second segment 46, therein spreading the two segments 44, 46 apart. As the first segment 44 and the second segment 46 separate, the minimum diameter D3 of the second ball opening 22 increases. Eventually, the minimum diameter D3 becomes larger than the diameter D1 of the ball 11. At this point, the ball 11 passes through the second ball opening 22 and enters the interior 36 of the scoop 14. Once the ball 11 passes into the interior 36 of the scoop 14, the first segment 44 and the second segment 46 return to their original positions. This makes the minimum diameter D3 of the second opening 22 smaller than the ball 11. The ball 11 is then trapped in the interior 36 of the scoop 14 and cannot exit the second ball opening 22.

Referring to FIG. 7 in conjunction with FIG. 1, it will be understood that once the ball 11 is trapped in the scoop 14, the ball 11 can be lifted away from the ground simply by moving the scoop 14 away from the ground. Using the handle 26 and the shaft 16, a user can then whip the throwing device 12 in an overhead arc. The rapid movement of the ball 11 creates a centrifugal force on the ball 11 that biases the ball 11 against the interior 36 of the scoop 14. As the throwing device 12 is rotated to a scoop-high apex, the centrifugal forces bias the ball 11 against the first ball opening 20 with enough force to overcome other frictional forces. The result is that the ball 11 exits the first ball opening 20 at a high velocity.

Referring to all figures, it can be understood that to use the throwing device 12, the throwing device 12 is first used to retrieve a ball 11 from the ground. This is done by simply positioning the scoop 14 above the ball 11 and pressing the scoop 14 against the ball 11. At this point, the ball 11 will enter the interior 36 of the scoop 14. The throwing device 12 can then be rapidly moved through an arc, wherein the ball 11 will exit the scoop 14 at or near the apex of the arc. The result is that the ball 11 is picked-up and thrown without ever being directly contacted by a user.

It will be understood that the embodiment of the present invention that is illustrated and described is merely exemplary and that a person skilled in the art can make many variations to that embodiment. For instance, the length, width and curve of the throwing device can be changed to accommodate different sized balls. All such embodiments are intended to be included within the scope of the present invention as defined by the claims.

What is claimed is:

1. A throwing device for throwing a ball with a ball diameter, said throwing device comprising:
a scoop having a closed end, a second ball opening opposite said closed end, and a first ball opening disposed between said closed end and said second ball opening, wherein said first ball opening and said second ball opening intersect on said scoop at an intersect angle of between 70 degrees and 110 degrees;
wherein said first ball opening has a first diameter that is at least as large as said ball diameter and said second ball opening has a second diameter that is normally smaller than said ball diameter, wherein said second ball opening expands to a size larger than said ball diameter when said ball is biased against said second ball opening with sufficient force, therein enabling said ball to pass into said scoop through said second opening;
a shaft extending from said closed end of said scoop.

2. The device according to claim 1, wherein said shaft has a length of at least fifty centimeters, and said shaft has a straight section that extends along at least seventy percent of said length.

3. The device according to claim 2, wherein said shaft bends into an inclined section, wherein said inclined section is interposed between said straight section and said scoop.

4. The device according to claim 3, wherein said inclined section is offset from said straight section by an offset angle of between thirty degrees and forty-five degrees.

5. The device according to claim 1, wherein said scoop is beveled about said second ball opening.

6. The device according to claim 1, further including a slot opening in said scoop that intersects said second ball opening.

7. The device according to claim 6, wherein said scoop has a first segment that extends between said slot opening and said first ball opening in a first direction and an opposite second segment that extends between said slot opening and said second ball opening in a second direction that is opposite said first direction.

8. The device according to claim 7, wherein said first segment is a mirror image of said second segment.

9. The device according to claim 7, wherein said second ball opening is disposed between said first segment and said second segment.

10. The device according to claim 9, wherein said first segment and said second segment are flexible and can be spread apart by said ball when biased against said ball, therein expanding said second ball opening.

11. A throwing device for throwing a ball having a ball diameter, said throwing device comprising:
a scoop having an interior accessible through a first ball opening and a second ball opening, wherein said first ball opening is at least as large as said ball diameter and said second ball opening is smaller than said ball diameter, wherein said second ball opening expands to a size that is larger than said ball diameter when said ball is biased against said second ball opening with a force in excess of a threshold force, therein enabling said ball to pass into said scoop through said second ball opening;
an elongated shaft extending from said scoop for use in moving said scoop through a throwing motion.

12. The device according to claim 11, wherein said first ball opening and said second ball opening intersect on said scoop at an intersect angle.

13. The device according to claim 11, wherein said intersect angle is between 70 degrees and 110 degrees.

14. The device according to claim 11, wherein said shaft has a length of at least fifty centimeters, and said shaft has a straight section that extends along at least seventy percent of said length.

15. The device according to claim 14, wherein said shaft bends into an inclined section, wherein said inclined section is interposed between said straight section and said scoop.

16. The device according to claim 15, wherein said inclined section is offset from said straight section by an offset angle of between thirty degrees and forty-five degrees.

17. The device according to claim 11, wherein said scoop is beveled about said second ball opening.

18. The device according to claim 11, further including a slot opening in said scoop that intersects said second ball opening.

19. The device according to claim 18, wherein said scoop has a first segment that extends between said slot opening and said first ball opening in a first direction and an opposite second segment that extends between said slot opening and said second ball opening in a second direction that is opposite said first direction.

20. The device according to claim 19, wherein said first segment and said second segment are flexible and can be spread apart by said ball when biased against said ball, therein expanding said second ball opening.
